(19) United States
(12) Patent Application Publication
(10) Pub. No.: US 2011/0029238 A1
(43) Pub. Date: Feb. 3, 2011

(54) Satellite Navigation Apparatus and Associated Method

(75) Inventors: MENG-SHU LEE, Hsinchu Hsien (TW); Yi-Chih Chou, Hsinchu Hsien (TW)

Correspondence Address: WPAT, PC;INTELLECTUAL PROPERTY ATTORNEYS, 7225 BEVERLY ST., ANNANDALE, VA, 22003, US

(73) Assignee: MStar Semiconductor, Inc., Hsinchu Hsien (TW)

(21) Appl. No.: 12/728,491

(22) Filed: Mar. 22, 2010

(30) Foreign Application Priority Data
Jul. 31, 2009 (TW) 098125880

(51) Int. Cl. G01C 21/30; G01C 21/34

(52) U.S. Cl. 701/210; 701/209

(57) ABSTRACT

A navigation method, which is applied to a satellite navigation apparatus, includes: determining whether the satellite navigation apparatus is in a free-run mode; and, when the satellite navigation apparatus is under the free-run mode, recording a route, which the satellite navigation apparatus passes through, in a database for the use of route planning of the satellite navigation apparatus in a navigation mode.

### CROSS REFERENCE TO RELATED PATENT APPLICATION

This patent application is based on a Taiwan, R.O.C. patent application No. 098125880 filed on Jul. 31, 2009.

### FIELD OF THE INVENTION

The present invention relates to a navigation mechanism, and more particularly, to a navigation apparatus and an associated method.

### BACKGROUND OF THE INVENTION

According to the prior art, a satellite navigation apparatus plans a navigation route with reference a geographic map database, so as to suggest the user a planned route to reach an end point. However, it is possible that the suggested planned route by the navigation apparatus does not realistically address to the user's requirements or habits. When a navigation apparatus generated planned route is provided to the user for traveling from an unfamiliar environment to a familiar environment, or vice versa, such planned route is generated based on merely a geographic database stored therein, it is much likely that paths of the planned route disagree with the user's actual requirements or habits. The user may nevertheless travel according to an accustomed route under a familiar environment instead of the suggested planned route from the navigation apparatus. In other words, the prior satellite navigation apparatus may provide the user with rather insufficient practicability while being unable to fully attend to the user's needs.

### SUMMARY OF THE INVENTION

Therefore, it is an objective of the invention to provide a navigation apparatus and an associated navigation method that offer high practicability by fully addressing to a user's needs.

The invention provides a navigation method applied to a satellite navigation apparatus. The method comprises: determining whether the navigation apparatus is under a free-run mode; and recording a route, which the satellite navigation apparatus passes through, in a database for the use of route planning of the satellite navigation apparatus in a navigation mode.

The invention further provides a navigation method applied to a satellite navigation apparatus. The method comprises: setting a start point and an end point; generating a planned route by utilizing a route planning algorithm of the satellite navigation apparatus according to the start point, the end point and a predetermined geographic database; and replacing a path of the planned route by a user-preferred sub route according to a database to determine a navigation route.

The invention further provides a navigation method applied to a satellite navigation apparatus. The method comprises: learning a learned route having a start link and an end link; generating a planned route according to the start link, the end link and a route planning algorithm; comparing the planned route with the learned route to generate a route comparison result; determining whether to update a database with the learned route according to the route comparison result.

The invention further provides a satellite navigation apparatus comprising a processing unit and a database. The processing unit determines whether the satellite navigation apparatus is under a free-run mode. The database, coupled to the processing unit, records a route which the satellite navigation apparatus passes through, in a database for the use of route planning of the satellite navigation apparatus in a navigation mode.

The invention yet provides a satellite navigation apparatus comprising a database and a processing unit. The database stores a user-preferred route. The processing unit, coupled to the database, sets a start point and an end point; generates a planned route according to the start point, the end point and a route planning algorithm; and replacing a path of the planned route with a path of the user-preferred route to determine a navigation route.

The invention yet provides a satellite navigation apparatus comprising a learning unit and a processing unit. The learning unit learns a learned route having a start link and an end link. The processing unit, coupled to the learning unit, generates a planned route according to the start link, the end link and a route planning algorithm; and compares the planned route with the learned route to determine whether to update a database according to the learned route.

An advantage of the present invention is that, whether being under a navigation mode or a free-run mode, the satellite navigation apparatus is capable of learning a user-preferred route. Therefore, next time when the user wishes to travel from a familiar environment to an unfamiliar environment or vice versa, a navigation route generated by the satellite navigation apparatus allows the user to arrive at an end point by prompting the user to pass through preferred streets under a familiar environment, thereby more realistically addressing to navigation needs of the user.

### BRIEF DESCRIPTION OF THE DRAWINGS

The present invention will become more readily apparent to those ordinarily skilled in the art after reviewing the following detailed description and accompanying drawings, in which:

FIG. 1 is a block diagram of a satellite navigation apparatus according to one embodiment of the invention;

FIG. 2 is a flowchart of routing learning performed by the satellite navigation apparatus shown in FIG. 1 under a free-run mode;

FIG. 3 is a flowchart of route planning of performed by the satellite navigation apparatus shown in FIG. 1;

FIG. 4A˜4G are schematic diagrams of path replacement with respect to a planned route P, performed by the satellite navigation apparatus shown in FIG. 1; and

FIG. 5 is a flowchart of route learning performed by the satellite navigation apparatus shown in FIG. 1.

### DETAILED DESCRIPTION OF THE PREFERRED EMBODIMENT

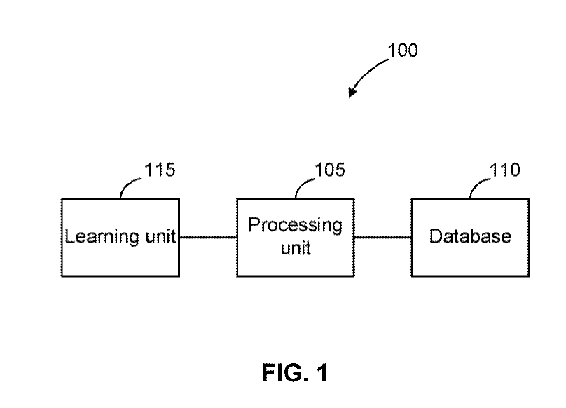

FIG. 1 shows a block diagram of a satellite navigation apparatus 100 according to one embodiment of the invention. The satellite navigation apparatus 100 comprises a processing unit 105, a database 110, and a learning unit 115. In this embodiment, the satellite navigation apparatus 100, applied to vehicles such as automobiles, is capable of route learning under both a navigation mode and a free-run mode.

The purpose of routing learning is to record a user-preferred (e.g., passenger-preferred or driver-preferred) route under a familiar environment for the use of future route planning. The processing unit 105 determines whether the satellite navigation apparatus 100 is under a free-run mode or a navigation mode. When the processing unit 105 indicates that the satellite navigation apparatus 100 is under a free-run mode, the learning unit 115 performs route learning to record a route (i.e., the database 110 is then stored with the user-preferred route), which is the currently travelling route passed through by the satellite navigation apparatus 100. The recorded route is for the use of routing planning by the satellite navigation apparatus 100 under a navigation mode. Further, when the satellite navigation apparatus 100, under a navigation mode, deviates from the planned route, the learning unit 115 also performs route learning to record a route, which is passed through by the satellite navigation apparatus 100 when deviated from the planned route. The learned routes are for the use of route planning by the satellite navigation apparatus 100 under a navigation mode according to a different start point or end point.

Since the satellite navigation apparatus 100 is capable of learning a user-preferred route under both a navigation mode and a free-run mode, the next time when the user wishes to travel from a familiar environment to an unfamiliar environment, or vice versa, a navigation route planned by the satellite navigation apparatus 100 allows the user to arrive at an end point by prompting the user to pass through preferred streets under a familiar environment. Therefore, through the satellite navigation apparatus 100, a navigation route that more realistically addresses to navigation needs of the user is provided.

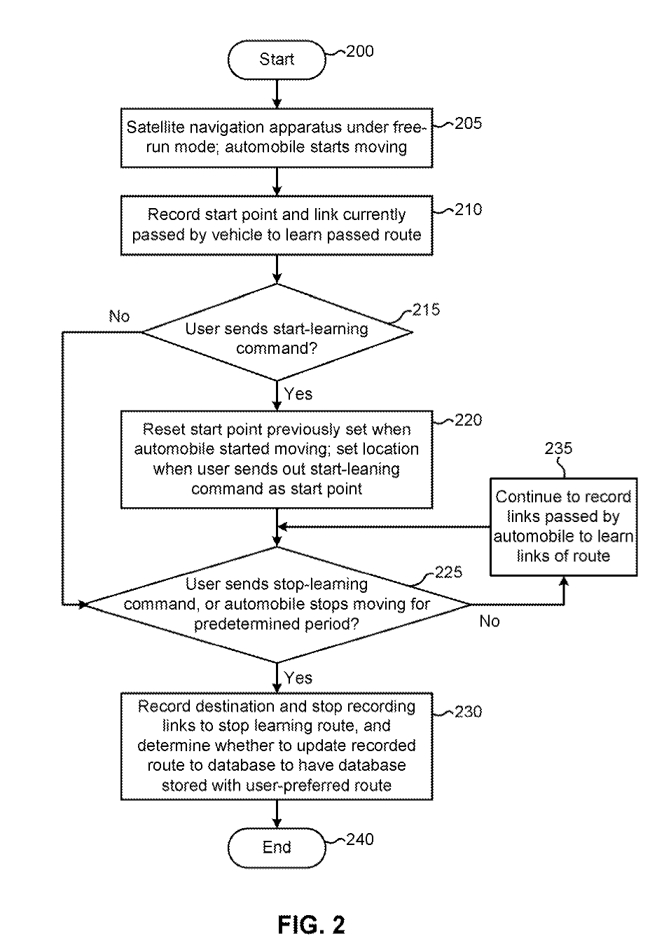

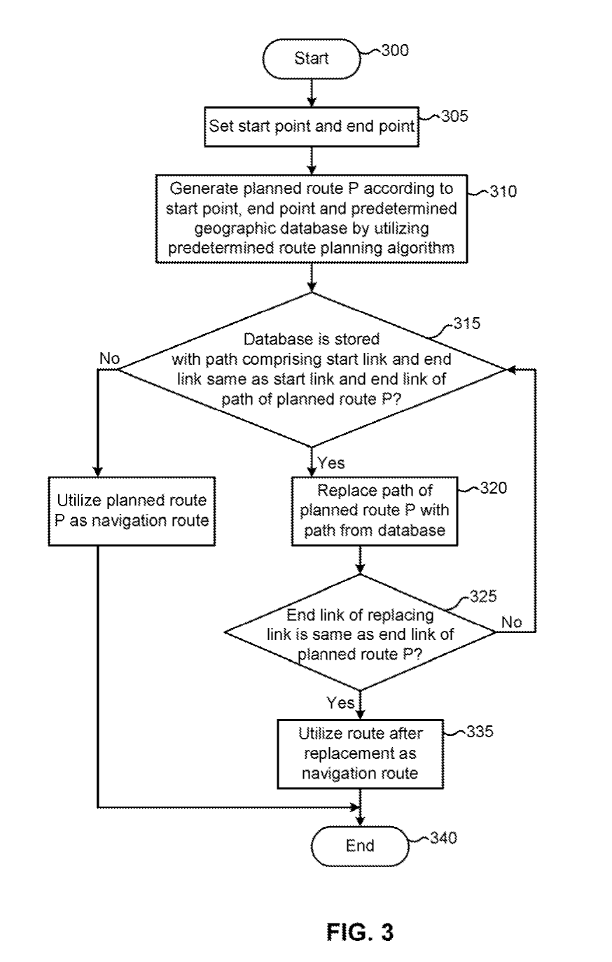

Routing learning of the learning unit 115 may be user-activated or automatically activated; information of a learned route, such as a start point, an end point, a departure time, an arrival time and a duration, is recorded to the database 110. FIG. 2 shows a flowchart of route learning of the satellite navigation apparatus 100 under a free-run mode. The steps in the flowchart need not be executed as the sequence shown in FIG. 2 nor be successive, provided that the same result is substantially achieved; that is to say, the steps in FIG. 3 can be interleaved with other steps.

Steps of the flowchart in FIG. 2 shall be described below. The flow begins with Step 200. In Step 205, the satellite navigation apparatus 100 is under a free-run mode, and an automobile starts moving. In Step 210, the learning unit 115 records a start point and a link that the automobile is currently passing through to learn such path as a learned route. In Step 215, the learning unit 115 determines whether the user sends a start-learning command. Step 220 is performed when a result from Step 215 is affirmative, or Step 225 is performed when the result is negative. In Step 220, the learning unit 115 resets the start point recorded when the automobile started moving, and sets a location at the time when the user sends the learning command as the start point. In Step 225, the learning unit 115 determines whether the user sends a stop-learning command, or determines whether the automobile stops moving for over a predetermined period. Step 230 is performed when a result from Step 225 is affirmative, or Step 235 is performed when the result is negative. In Step 230, the learning unit 115 records an end point and stops recording links passing through to stop learning the route. The processing unit 105 then determines according to a route update process, whether to update the database 110 with the route recorded by the learning unit 115 so that the database 110 is recorded and stored with a user-preferred route. In Step 235, the learning unit 115 continues to record links that the automobile is passing through to learn the links of the route. The flow ends at Step 240.

As described in Steps 210 and 215, the learning unit 115, according to either an activation command from the user or a location change status (e.g., when the automobile starts moving), activates the route learning function to set the start point of the route passing through; according to a deactivation command from the user or a location change status (e.g., when the automobile remains stationary for a predetermined period), sets the end point of the route. Further, when Step 220 follows Step 215 in the flowchart in FIG. 2, it means that an activation command for routing learning is sent out from the user (e.g., the user presses a button from a human-machine-interface), so that the learning unit 115 resets the start point recorded when the automobile started moving, and sets the location at the time when the user sends the command for routing learning as the start point.

FIG. 3 shows a flowchart of routing planning by the satellite navigation apparatus 100 shown in FIG. 1. The flowchart begins with Step 300. In Step 305, a user sets a start point and an end point. In Step 310, the processing unit 105, according to the start point, the end point, and a predetermined geographic database, generates a planned route P by utilizing a predetermined routing planning algorithm. In Step 315, the processing unit 105 determines whether the database 110 is stored with a path, whose start link and end link are the same as a start link and an end link of a path of the planned route P. When a result from Step 315 is affirmative, Step 320 is performed; when the result is negative, Step 330 in which the processing unit 105 utilizes the planned route P as the navigation route is performed. In Step 320, the processing unit 105 replaces the path of the planned route P with the path from the database 110. In Step 325, it is determined whether the end link of the replacing path is the same as the end link of the planned route P. Step 335 is performed when a result from Step 325 is affirmative, or Step 315 is iterated when the result is negative. In Step 335, the processing unit 105 utilizes the route after a final replacement as the navigation route, and the flow ends at Step 340.

Substantially, provided that the start point and the end point are set by the user, the processing unit 105 first generates the planned route P, and replaces a path of the planned route with at a path of at least one user-preferred route according to the database 110 to determine the final navigation route. Further, the processing unit 105, according to the database 110, generates the navigation route by determining whether a time-dependent route exists in the database 110, i.e., the path of the user-preferred route is then replaced by the time-dependent route. When the time-dependent route exists in the database 110, the processing unit 105 replaces the path of the planned route P with the time-dependent route. In contrast, when the time-dependent route is absent in the database 110, the processing unit 105 replaces the path of the planned route P with a time-independent route. More specifically, when a time-dependent route and a time-independent route are concurrently available for replacing a path of the planned route P, the processing unit 105 chooses the precedence time-dependent route for replacement. More details on the time-dependent route and the time-independent route shall be discussed later. In Step 315 to Step 325, the processing unit 105 replaces at least one path of the planned route P by implementing greedy algorithm, so that at least one part of the final navigation route is a path from the user-preferred route. In this embodiment, a path is defined to be consisted of a plurality of successive links of a certain route; that is, two successive links may compose a path, or the route itself may be considered as a path. For example, when a route is in sequence consisted of a plurality of successive links p1˜p10, two of which (e.g., p1 and p2) are then considered as a path, and the links p1˜p10 (i.e., the route) is also considered as another path. Further, in this embodiment, a link is a geographical information link that corresponds to a roadway (e.g., street, road, alley or lane), a start point and an end point of which are respectively a fork of an intersection and have no junctions in between. In addition, the foregoing start link comprises the link attached to the start point and the end link comprises the link attached to the end link.

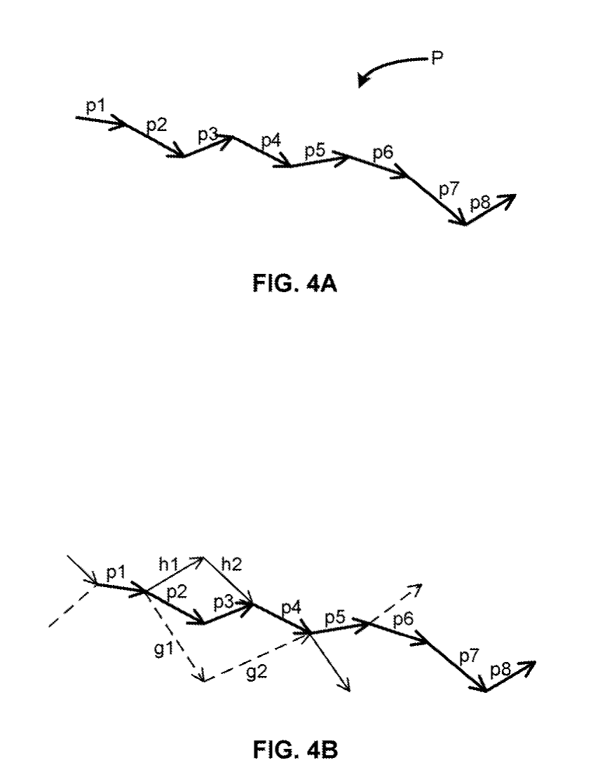

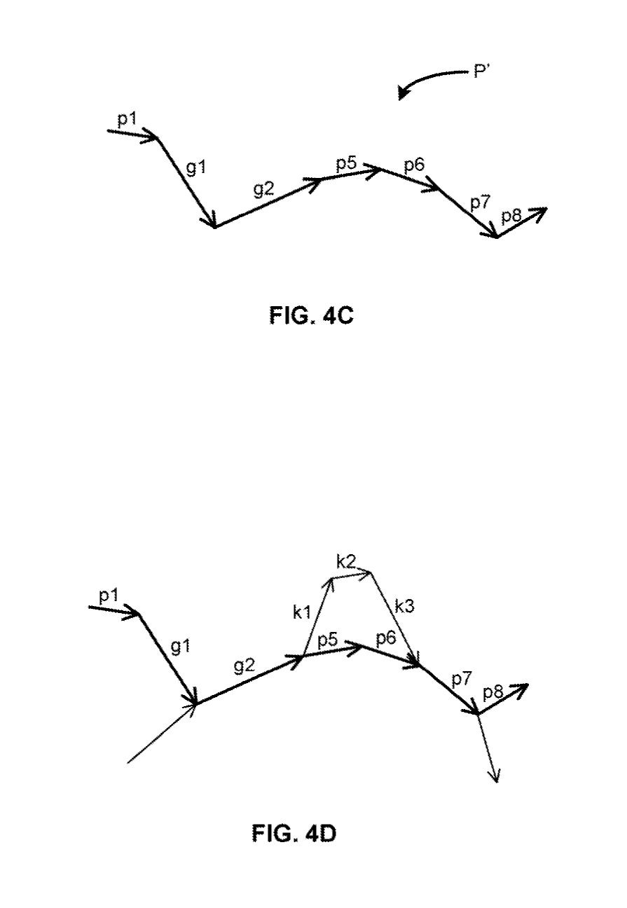

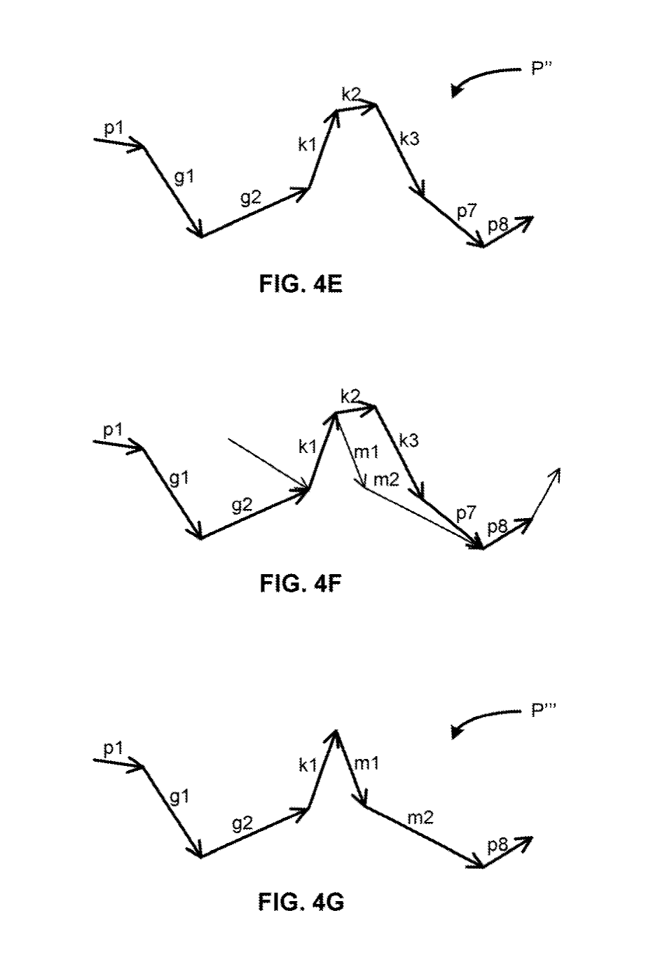

FIG. 4A to 4E show schematic diagrams illustrating how the satellite navigation apparatus 100 in FIG. 1 performs path replacement with respect to the planned route P generated by the processing unit 105. With reference to FIG. 4A, the planned route in sequence comprises a plurality of successive links p1˜p8, and the processing unit 105 starts path replacement from the start link p1. First, the processing unit 105 searches the database 110 for a path, which has p1 as a start link and any link from p2˜p8 as an end link. For example, in FIG. 4B, the database 110 is stored with a first path and a second path—the first path comprises successive links p1, g1, g2 and p5, and the second path comprises successive links p1, h1, h2 and p4. The processing unit 105 then, between the first path and the second path, selects a path with an end link p5 that is closer to the end link p8; that is, the first path comprising the links p1, g1, g2 and p5 is selected for path replacement. After path placement, the processing unit 105 obtains a replaced route P′ comprising successive links p1, g1, g2 and p5˜p8, as shown in FIG. 4C. The processing unit 105 continues path replacement, regarding the link g2 as the start link. Similarly, the processing unit 105 searches the database 110 for a path, which has g2 as a start link and any link from p5˜p8 as an end link, and selects a path comprising successive links g2, k1, k2, k3 and p7, as shown in FIG. 4D. Therefore, with the present path replacement step, the processing unit 105 obtains a replaced route P″ comprising the successive links p1, g1, g2, k1˜k3, p7 and p8, as shown in FIG. 4E. The processing unit 105 again starts path replacement, regarding the link k1 as the start link. In the present path placement step, the processing unit 105 selects from the database 110 a path comprising successive links k1, m1, m2 and p8, as shown in FIG. 4F. Thus, with the present path replacement, the processing unit 105 obtains a path P′″ comprising the successive links p1, g1, g2, k1, m1, m2 and p8, as shown in FIG. 4G. Since the path replacement has reached the end link p8 of the planned route P, the processing unit 105 ends the greedy algorithm, and utilizes the route P′″ comprising the successive links p1, g1, g2, k1, m1, m2 and p8 as the navigation route. In other words, when a driving user selects a start point and an end point with p1 as the start link and p8 as the end link, the satellite navigation apparatus 100 determines the navigation route comprising the successive links p1, g1, g2, k1, m1, m2 and p8 as a suggested preferred route to the user.

It is to be noted that, the links p1˜p8 of the planned route are used as an example for illustrating the embodiment but not to limit the invention thereto. The planned route P may be composed in sequence by a plurality of successive links p₁˜p_{N}, where N is a positive integer greater than 2, and the start points and end points of the roadways corresponding to the links p₁˜p_{N} are defined by different junctions. The processing unit 105 performs at least one operation from the following: determining whether the database 110 stores a first user-preferred path comprising a link pᵢ and a link pⱼ, where the link pᵢ and the link pⱼ are from the links p₁˜p_{N}, j is a positive integer greater than i, and the first user-preferred path also comprises at least a link p′ located between the link pᵢ and the link pⱼ; and when the database 110 is stored with the first user-preferred path, replacing a link located between the link pᵢ and the link pⱼ of the planned route according to the at least one link p′ of the first user-preferred path.

When the database 110 also stores a second user-preferred path comprising the link pᵢ and another link pₖ, where k is a positive integer greater than j, and the second user-preferred path comprises at least one path p″ located between the link pᵢ and the link pₖ, the processing unit 105 replaces a link located between the link pᵢ and the link pₖ of the planned route with the at least one link p″ of the second user-preferred path. Such mechanism is an operation based on the greedy algorithm for finding a preferred user-preferred route.

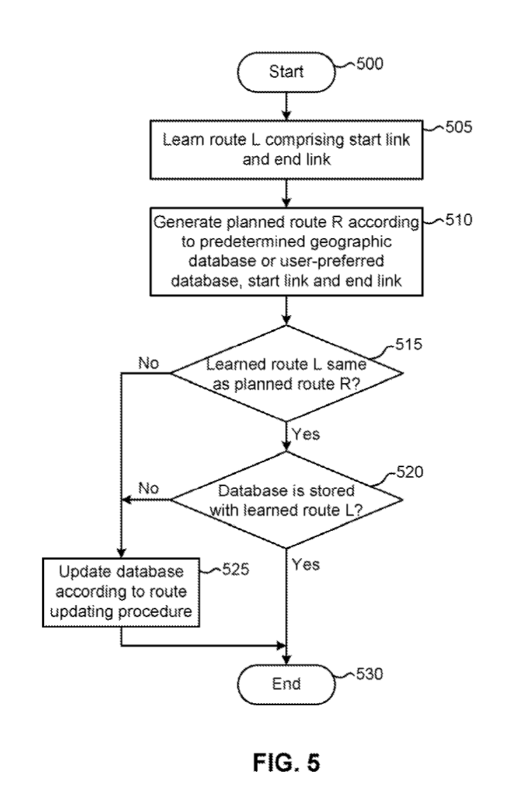

FIG. 5 shows a flowchart of route learning by the satellite navigation apparatus 100 in FIG. 1. The flow starts with Step 500. In Step 505, the learning unit 115 learns a learned route L having a start link and an end link, and outputs the learned route to the processing unit 105. In Step 510, the processing unit 105, according to a predetermined geographic database or the database 110 stored with user-preferred information, the start link and the end link, generates a planned route R by utilizing the greedy algorithm. In Step 515, the processing unit 105 determines whether the learned route R is the same as the planned route R. When a result from Step 515 indicates that the learned route R and the planned route R are the same, Step 520 is performed, or Step 525 is performed when they are different. In Step 520, the processing unit 105 determines whether the database 110 is stored with the learned route L. When a result from Step 520 is affirmative, Step 530 is performed, or Step 525 is performed when the result is negative. In Step 525, the processing unit 105 updates the database 110 according to a route update procedure, and the flow then ends at Step 530.

One of the objectives of the flow in FIG. 5 is to determine whether to utilize any path of the learned route L to update route information or path information of the database 110, so as to appropriately reduce the number of times in updating the database 110. Steps 515, 520 and 525 may be regarded as steps in which the processing unit 105 generates a route comparison result from comparing the planned route R and the learned route L, and then determines whether to update the database according to the learned route L. More specifically, since the planned route R is generated from route information of at least one of the predetermined geographic database and the database 110, it means the database 110 is not stored with information of the learned route L when the route comparison result indicates the learned route L differs from the planned route R, thus the learned route L need be updated into the database 110. Conversely, when the route comparison result indicates that the learned route L is the same as the planned route R, it means the learned route L may or may not exist in the database 110. Therefore, Step 520 is performed in this embodiment to examine whether the learned route L exists in the database 110. More specifically, when the planned route R differs from the learned route L, or when the planned route R is the same as the learned route R that is however not a path of a user-preferred route in the database 110, the processing unit 105 updates the database 110 according to the learned route L. Further, when the planned route R is the same as the learned route R that is however not a path of a user-preferred route in the database 110, the processing unit 105 selectively adds the learned route L into the database 110. When the planned route L is the same as the learned route L that is already a path of a user-preferred route stored in the database 110, the processing unit 105 does not update the database 110 according to the learned route L; that is, the processing unit 105 discards the learned route L and keeps content of the database 110 intact.

Information stored in the database 110 is categorized into time-dependent routes and time-independent routes. A time-dependent route is a route that a user passes through at a predetermined time or date. For example, supposing the user passes through a certain route at a predetermined time, e.g., 8:00 am, the route is categorized as a time-dependent route by the database 110. A time-independent route is a route that a user passes through at different times or dates. For example, supposing a same learned route is obtained by the satellite navigation apparatus 100 operating at different time ranges, e.g., different hours in the morning, afternoon and evening, or within different days of a week, the learned route is categorized as a time-independent route by the database 110. For a priority in routing planning, a time-dependent route is given precedence over a time-independent route when being selected by the processing unit 105 for route replacement. For example, when a user activates the satellite navigation apparatus 100 for route planning at a predetermined time, the processing unit 105, to perform route replacement, searches time-dependent routes stored in the database 110 for a route, which belongs to a same time range as the predetermined time and has a path for replacing a path of the planned route. When the processing unit 105 is unable to find a route from the time-dependent routes for route replacement, it then searches time-independent routes for a route, which belongs to the same time range as the predetermined time and has a path for replacing a path of the planned route to perform path replacement. It is to be noted that, the processing unit 105 categorizes a learned route that is learned for the first time as a time-dependent route. After that, supposing the processing unit 105 again or repeatedly learns the same learned route under a different time range, the learned route is then categorized as a time-independent route. Further, information of a user-preferred route stored in the database 110 includes links, a total time cost, individual cost of the links and other related information (e.g., driving information of different users).

Again with reference to FIG. 5, when performing a route update procedure, different scenarios on how the processing unit 105 updates content of the database is discussed as the following. The route update procedure compares a planned route with a learned route to determine whether to update the database 110 according to the learned route. For example, the learned route L comprises a plurality of successive links L1˜L8 driven through by a user, wherein L1 is a start link and L8 is an end link; the planned route R generated by the processing unit 105 comprises a plurality of successive links L1, R2˜Rn, and L8.

In a first scenario, the Step 530 is performed after the Step 520. In this first scenario, the learned route L is the same as the planned route R (i.e., the links R2˜Rn are the same as the links L2˜L7, respectively) and is already stored in the database 100. Thus, the processing unit 105 need not update content of the database 110 with the learned route R, and the flow ends at Step 530.

In a second scenario, the Step 525 is performed after the Step 520. In this second scenario, the learned route R is the same as the planned route R, but however it is not a user-preferred route which has been stored in the database 110. The processing unit 105 then updates the database 110 by directly adding the learned route L to the database 110. Further, due to being learned for the first time by the learning unit 115, the learned route L is categorized as a time-dependent route.

In a third scenario, the Step 525 is performed after the Step 515. In this third scenario, the processing unit 105 generates a first cost comparison result by comparing an overall time cost of the learned route L with an overall time cost of the planned route R. According to the first cost comparison result, the processing unit 105 then determines that a time cost difference between the learned route L and the planned route R does not exceed a predetermined threshold, which means a relative time cost is within an acceptable range to the user although partial links of the learned route L and the planned route are different. Thus, the processing unit 105 decides to update the database 110 with the learned route L according to the first cost comparison result, and determines whether a path stored in the database 110 comprise any two links of the learned route L. More specifically, the processing unit 105 determines whether the start link and the end link of the learned route L are included in any user-preferred route stored in the database 110. When a path comprising both links is not in the database 110 (i.e., only a certain path comprising one of the links is available in the database 110), it means the path of the learned route L does not exist in the database 110. Therefore, the processing unit 105 updates content of the database 110 by directly adding the learned route R into the database 110. Conversely, when a path comprising both links from the learned route L is in the database 110 (i.e., the start link and the end link of the learned rout L are included in a user-preferred route stored in the database 110), it implies a path formed by successive links between the two links is suitable for updating content of the database 110. Hence, the processing unit 105 further compares time costs of the path of the learned route L and the specific path from the database 110 to determine whether to add the learned route L to the database 110. For example, a route M in the database 110 in sequence comprises seven successive links M1˜M7. The link M2 of the route M is substantially the same as the link L4 of the learned route L, and the link M6 of the route M is substantially the same as the link L8 of the learned route L; that is, a path L′ comprising the links L4˜L8 of the learned route L has the same start and end links as a path M′ comprising the links M2˜M6 stored in the database 110. At this point, the processing unit 105 compares a total time cost of the path L′ with a total time cost of the path M′ to determine whether to replace the path M′ comprising the links M2˜M6 with the path L′ comprising the links L4˜L8. When a difference between the total time costs of the paths L′ and M′ does not exceed a predetermined threshold (i.e., the total time cost of the path L′ is within an acceptable range), the processing unit 105 updates the database 110 by directly replacing the path M′ of the route M in the database 110 with path L′ of the learned route L, and adds the learned route L to the database 110. In other words, the route M originally comprising the links M1˜M7 becomes a route formed by the links M1, L4˜L8, and M7 in sequence. Conversely, when the difference between the total time costs of the paths L′ and M′ exceeds the predetermined threshold (i.e., the total time cost of the path L′ is beyond an acceptable range), the processing unit 105 leaves the decision of whether to update the path M′ of the route M with the path L′ of the learned route L to the user, e.g., by a user command. That is to say, when the time cost of the path L′ exceeds the acceptable range, the user is still allowed to add the recently learned user-preferred route to the database 110. Alternatively, the processing unit 105 may place the path L′ to an observation list, which is to be referred to when the path L′ is again learned in order to determine whether to replace the path M′ in the database 110 with the path L′.

In a fourth scenario, the learned route L differs from the planned route, and the processing unit 105 determines that the difference between time costs of the learned route L and the planned route R exceeds the predetermined threshold according to the first cost comparison result, to indicate that the time cost of the learned route L exceeds the acceptable range. At this point, the processing unit 105 leaves the decision of whether to update the database 110 with the learned route L to the user. That is to say, when the time cost of the learned route L exceeds the acceptable range, the user is still allowed to add the recently learned user-preferred route to the database 110. Alternatively, the processing unit 105 may place the learned route L to an observation list, which is to be referred to when the path L′ is again learned in order to determine whether to update the database 110 with the learned route L.

Conclusive from the third and fourth scenarios, the processing unit 105 first compares time costs of the learned route L and the planned route R to generate the first cost comparison result, and determines whether to update the database 110 with the learned route L according to the first cost comparison result. In the third scenario, when the first cost comparison result indicates that the difference between the time costs of the learned route L and the planned route R does not exceed the predetermined threshold, the processing unit 105 then determines whether the start link and the end link of the learned route L are included in any user-preferred route in the database 110. When the path of the learned route L is not included in any user-preferred route in the database 110, the processing unit 105 adds the learned route L to the database 110. When the path of the learned route L is included in any user-preferred route in the database 110, the processing unit 105 compares a time cost of the path of the learned route with a time cost of the path of the user-preferred route to generate a second cost comparison result, and determines whether to update the database 110 with the learned route L according to the second cost comparison result. When a difference between time costs of the path of the learned route L and the path of the user-preferred route does not exceed the predetermined threshold, the processing unit 105 updates the database 110 by replacing the path of the user-preferred route with the path of the learned route L. In the fourth situation, when the foregoing difference exceeds the predetermined threshold, the processing unit 105 determines whether to update the database 110 by replacing the path of the user-preferred route with the path of the learned route L according to the user command, or the processing unit 105 places the path of the learned route L to an observation list for future reference when again updating the database 110.

Apart from being applied to a vehicle as in the above embodiments, the satellite navigation apparatus 100 can also be applied to a portable device, e.g., a mobile phone or a personal digital assistant. For example, when a user wishes to travel from a start point to an end point on foot, more humanized navigation route may be obtained via the satellite navigation apparatus 100. The obtained navigation route may further include paths passed through by public transportation means such as the railway or rapid transit; that is, the navigation route is capable of instructing the user to take public transportation to more realistically address to the user's needs.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A navigation method, applied to a satellite navigation apparatus, comprising:
determining whether the satellite navigation apparatus is under a free-run mode;
recording a first traveling route into a database of the satellite navigation apparatus when the satellite navigation apparatus is under the free-run mode; and
providing the first traveling route by the satellite navigation apparatus for route planning when the satellite navigation apparatus is under a navigation mode.

2. The navigation method as claimed in claim 1, further comprising:
determining whether the satellite navigation apparatus provides a planned route under the navigation mode; and
recording a second travelling route into the database of the satellite navigation apparatus when the second travelling route is deviating from a planned route from the satellite navigation apparatus under the navigation mode.

3. The navigation method as claimed in claim 1, wherein the recording step further comprises:
setting a start point of the first traveling route according to a user activation command for activating a route planning function and a location change status of the satellite navigation apparatus;
recording the first traveling route;
setting an end point of the first traveling route according to a user termination command for terminating the route planning function or after the location change status of the satellite navigation apparatus indicating a halt for a predetermined period; and
stopping recording the first traveling route.

4. A navigation method, applied to a satellite navigation apparatus, comprising:
learning a traveling route comprising a start link and an end link;
generating a planned route according to the start link, the end link, and a route planning algorithm;
generating a route comparison result by comparing the learned traveling route with the planned route; and
selectively updating a database according to the route comparison result.

5. The navigation method as claimed in claim 4, wherein the selectively updating the database according to the route comparison result, further comprises:
discarding the learned traveling route and keeping the database intact when the route comparison result indicates that the planned route is identical to the learned traveling route and the learned traveling route is already stored in the database.

6. The navigation method as claimed in claim 4, wherein the selectively updating the database according to the route comparison result, further comprises:
storing the learned traveling route into the database when the route comparison result indicates that the planned route is identical to the learned traveling route and the learned traveling route is not stored in the database, or storing the learned traveling route into the database when the route comparison result indicates that the planned route differs from the learned traveling route.

7. The navigation method as claimed in claim 6, wherein storing the learned traveling route into the database when the route comparison result indicates that the planned route differs from the learned traveling route, further comprises:
generating a first compared time cost by comparing the learned traveling route with the planned route; and
storing the learned traveling route into the database when the first compared time cost is within a first threshold.

8. The navigation method as claimed in claim 7, wherein the storing the learned traveling route into the database when the first compared time cost is within a first threshold, further comprises:
determining whether the start link and the end link are included in a first user-preferred route stored in the database; and
storing the learned traveling route into the database when the start link and the end link are not included in the first user-preferred route stored in the database.

9. The navigation method as claimed in claim 7, wherein the storing the learned traveling route into the database when the first compared time cost is within a first threshold, further comprises:
determining whether the start link and the end link are included in a first user-preferred route stored in the database;
generating a second compared time cost by comparing the learned traveling route with the first user-preferred route when the start link and the end link are included in the first user-preferred route stored in the database; and
updating the first user-preferred route in the database with the learned traveling route when the second compared time cost is within a second threshold.

10. The navigation method as claimed in claim 6, wherein storing the learned traveling route into the database when the route comparison result indicates that the planned route differs from the learned traveling route, further comprises:
generating a first compared time cost by comparing the learned traveling route with the planned route; and
storing the learned traveling route into the database when the first compared time cost is not within a first threshold and the satellite navigation apparatus receives a user updating instruction.

11. The navigation method as claimed in claim 4, wherein the selectively updating a database according to the route comparison result, further comprises:
categorizing the learned traveling route as a time-dependent user-preferred route if the learned traveling route is inserted into the database for a first time; and
categorizing the learned traveling route as a time-independent user-preferred route if the learned traveling route is to update a stored route in the database.

12. A satellite navigation apparatus, comprising:
a learning unit, for learning a route comprising a start link and an end link; and
a processing unit, coupled to the learning unit, for generating a planned route according to the start link, the end link, and a route planning algorithm, and selectively updating a database with the learned route according to the planned route and the learned route.

13. The satellite navigation apparatus as claimed in claim 12, wherein the processing unit updates the database with the learned route when the planned route differs from the learned route.

14. The satellite navigation apparatus as claimed in claim 12, wherein the processing unit updates the database with the learned route when the planned route is identical to the learned route and the learned route is not a user-preferred route stored in the database.

15. The satellite navigation apparatus as claimed in claim 12, wherein the processing unit discards the learned route and keeps the database intact when the planned route is identical to the learned route and the learned route is a user-preferred route stored in the database.

16. The satellite navigation apparatus as claimed in claim 13, wherein the processing unit updates the database by inserting the learned route into the database when the learned route is identical to the planned route and is not a user-preferred route in the database.

17. The satellite navigation apparatus as claimed in claim 13, wherein when the planned route differs from the learned route, the processing unit generates a first compared time cost from comparing the learned route with the planned route, and selectively updates the database according to the first compared time cost.

18. The satellite navigation apparatus as claimed in claim 17, wherein when the first compared time cost exceeds a predetermined threshold, the processing unit updates the database with the learned route according to a user command.

19. The satellite navigation apparatus as claimed in claim 17, wherein when the first compared time cost exceeds a predetermined threshold, the processing unit places the learned route to an observation list as a reference for updating the database.

20. The satellite navigation apparatus as claimed in claim 12, wherein the processing unit categorizes the learned route as a time-dependent user-preferred route when the learned route is inserted into the database for the first time, and categorizes the learned route as a time-independent user-preferred route when the learned route is to update a stored user-preferred route in the database.
